(19) United States
(12) Patent Application Publication
(10) Pub. No.: US 2018/0031319 A1
(43) Pub. Date: Feb. 1, 2018

(54) A METHOD OF STABILIZING A SUBSTRATE AND A MACHINE FOR PERFORMING THE METHOD

(71) Applicant: ION BEAM SERVICES, Peynier (FR)

(72) Inventors: Frank TORREGROSA, Simiane (FR); Laurent ROUX, Marseille (FR); Yohann SPIEGEL, Saint Maximin la Sainte Baume (FR)

(73) Assignee: ION BEAM SERVICES, Peynier (FR)

(21) Appl. No.: 15/552,094

(22) PCT Filed: Feb. 17, 2016
(86) PCT No.: PCT/FR2016/000027

§ 371 Date: Aug. 18, 2017

(30) Foreign Application Priority Data
Feb. 19, 2015 (FR) 15/00320

(51) Int. Cl. F26B 25/06

(52) U.S. Cl. CPC F26B 25/06

(57) ABSTRACT

A method of treating a substrate 23 includes a doping step followed immediately by a stabilization step. The method is remarkable in that the stabilization step involves immersing the substrate in a gas forming part of the set consisting of: oxygen; water vapor; wet air; hydrogen peroxide vapor; ozone; and ammonia. Also disclosed is a machine for treating a substrate in accordance with the above method and including a gas introduction orifice.

### CROSS REFERENCE TO RELATED APPLICATIONS

This application is a National Stage of International Application No. PCT/FR2016/000027 filed Feb. 17, 2016, claiming priority based on French Patent Application No. 15/00320 filed Feb. 19, 2015, the contents of all of which are incorporated herein by reference in their entirety.

### BACKGROUND OF THE INVENTION

The present invention relates to a method of stabilizing a substrate and to a machine for performing the method.

The field of the invention is that of microelectronics in which a substrate is subjected to doping.

The person skilled in the art knows numerous techniques for doping, including in particular ion implantation.

Doping consists in modifying the semiconductor properties of the substrate. Thus, by way of example, in order to dope a silicon substrate, elements are implanted therein that are taken from column III or from column V of the periodic table. For the person skilled in the art, bombarding a substrate with an inert gas (e.g. argon or krypton) does not amount to doping since those elements have outer electron shells that are complete.

Ion implantation is presently in widespread use in plasma immersion mode. In that technique, the substrate is immersed in a plasma and it is biased with a negative voltage lying in the range a few tens of volts to several tens of kilovolts, in order to establishes an electric field capable of accelerating the ions of the plasma towards the substrate so that they become implanted therein. The bias voltage is generally pulsed.

The problem is that certain dopants such as phosphorous or arsenic tend to react with ambient air in order to form gases that are very highly toxic, such as phosphine PH₃ or arsine AsH₃. In ambient air it is water vapor and oxygen that participate in these chemical reactions.

For phosphorous, the main reactions are as follows:

2P₂+6H₂O->3H₃PO₂+PH₃

2P₂+5O₂->P₄O₁₀

For arsenic, the main reactions are as follows:

4As+3H₂O->As₂O₃+2AsH₃

4As+3O₂->2As₂O₃

As₂O₃+O₂->As₂O₅

Mention may also be made of another dopant, namely boron, which can release B₂H₆.

In the present description, atomic layer deposition (ALD) techniques are considered as being doping techniques.

It can thus be seen that, providing the quantities of toxic gas that are generated are small, there is generally little difficulty because dilution in ambient air suffices to reduce the concentrations to below the values that are acceptable in various legislations.

In contrast, in advanced microelectronics, the treated substrates are stored in closed boxes known as front opening unified pods (FOUPs). The concentration of toxic gas in a FOUP can reach dangerous thresholds.

It is therefore appropriate to stabilize the surface of the substrate, and one known solution for avoiding this problem consists in encapsulating the substrate in a passivation or “cap” layer prior to putting it back in the atmosphere. This layer is made of silicon or of silicon oxide or of silicon nitride and has a thickness of a few nanometers.

By way of example, that solution is explained in Documents US 2008/277715 and U.S. Pat. No. 4,144,100.

That solution suffers from several limitations.

Firstly, deposition needs to be performed “in situ” in the same machine as is used for doping and without breaking the vacuum, thereby increasing the complexity of the machine and the cost of treatment, while also reducing productivity.

Secondly, the deposit needs to be removed before it is possible to make contact with the doped surfaces. Such removal needs to be controlled very accurately in order to avoid over-etching the surface, since that would lead to a loss of dopants. Removal must be total but without involving the doped surface.

Thirdly, those deposition and etching methods constitute a major source of variability in the operation of the associated component. The ever smaller dimensions of components has led to using a doping depth of about 5 nanometers. As a result, deposition and etching need to be performed with accuracy that is of the order of one-tenth of a nanometer, which is practically impossible at the present time.

### SUMMARY OF THE INVENTION

An object of the present invention is thus to provide a method and a machine that make it possible to overcome the limitations of the prior art.

According to the invention, a method of treating a substrate comprises a doping step followed immediately by a stabilization step, the method being remarkable in that the stabilization step consists in immersing the substrate in a gas forming part of the set comprising: oxygen; water vapor; wet air; hydrogen peroxide vapor; ozone; and ammonia.

The reaction of the doped surface is thus caused to take place in a confined atmosphere, thereby eliminating any danger resulting from the toxic gases produced by that reaction.

In a first option, the stabilization step consists in sweeping the substrate with the gas.

In a second option, the stabilization step consists in performing at least one cycle comprising a step of introducing the gas followed by a step of purging by pumping.

Preferably, the doping step is performed by ion implantation.

Advantageously, the ion implantation is performed by plasma immersion.

In a preferred implementation, the stabilization step includes a stage of heating the substrate.

According to an additional characteristic of the invention, the gas consists in gaseous species coming from a plasma.

For safety reasons, the stabilization step is followed by a step of analyzing the residual atmosphere.

The invention also provides a machine for treating a substrate with the above method, which machine comprises a doping chamber and an orifice for introducing the gas, the machine being remarkable in that it includes a stabilization member outside the doping chamber, the stabilization step being performed in the member.

In a first option, the stabilization member is an evacuated airlock.

In a second option, the stabilization member is a stabilization chamber.

### BRIEF DESCRIPTION OF THE DRAWINGS

The present invention appears below in greater detail from the following description of implementations given by way of illustration and with reference to the accompanying figures, in which:

FIG. 1 shows a machine for performing the method of the invention; and

FIG. 2 shows a stabilization chamber.

Elements that are identical in more than one of the figures are given the same references in each of them.

### DETAILED DESCRIPTION OF THE INVENTION

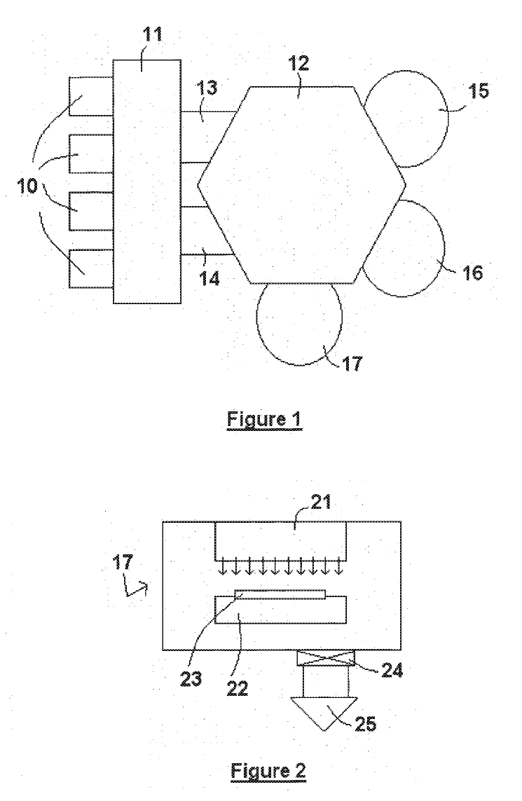

With reference to FIG. 1, there can be seen a doping machine. Starting from the left of the figure, there can be seen four FOUP loading trays 10. These trays 10 feed a first loading robot 11 which operates at atmospheric pressure.

This first robot 11 communicates with a second loading robot 12 that operates under a vacuum, and does so via a first loading/unloading airlock 13 and a second loading/unloading airlock 14. These two loading/unloading airlocks 13 and 14 also operate under a vacuum.

The second robot 12 feeds a first implantation chamber 15.

Optionally it feeds a second implantation chamber 16.

According to the invention, provision may also be made for a stabilization chamber 17 that is likewise fed by the second loading robot 12.

The treatment method of the invention thus comprises a doping step which, in the present example, is performed in an implantation chamber.

Immediately after the doping step, i.e. without putting the substrate back into an atmosphere, there follows a stabilization step for the purpose either of desorbing (degassing) toxic species, or else of saturating dangling bonds of highly doped surfaces. This step is performed under a controlled atmosphere in order to reduce the reactivity of the substrate with the atmosphere when it is put back into air.

In a first approach, the surface is stabilized by oxidizing using oxygen, water vapor, wet air, hydrogen peroxide vapor, or ozone.

In a second approach, the surface is stabilized by nitriding using nitrogen or preferably ammonia (NH₃).

Stabilization is performed merely by putting the substrate into contact with one of the above-mentioned gases.

These gases can be used in molecular form or indeed in the form of gaseous species that have been excited or ionized by means of a plasma.

In certain situations, it may be necessary to heat the substrate in order to accelerate the stabilization process. By way of example, in order to neutralize a phosphorus-doped surface with water vapor, it is desirable to raise the substrate to a temperature higher than 200° C.

A first possibility for performing stabilization consists in sweeping the surface of the substrate with the reactive gas. Typically, the working pressure lies in the range 0.01 millibars (mbar) to 100 mbar, and the flow rate lies in the range 50 standard cubic centimeters per minute (sccm) to 1000 sccm.

A second possibility consists in providing a cycle during which a step of introducing the gas into the enclosure is followed by a step of purging by pumping. The number of cycles needed can be determined empirically. Typically, pressure excursions lie in the range 0.1 mbar to 100 mbar, and the number of cycles lies in the range 3 to 10.

Nevertheless, it is possible to use a gas analyzer in order to evaluate the toxicity of the residual atmosphere. When a toxic gas is detected, a device can prevent the substrate being released and relaunch a stabilization stage.

The stabilization method may be performed “in situ” in the doping chamber, which has the advantage of passivating the walls of the chamber. Nevertheless, productivity is then affected and there is a risk of the atmosphere being contaminated by the residual pressure of reactive gas.

It is therefore preferable to perform stabilization in a stabilization member situated outside the doping chamber.

A first solution consists in using as a stabilization member an evacuated loading/unloading airlock 13, 14.

A second solution consists in using as a stabilization member a stabilization chamber 17 that is dedicated for that purpose.

With reference to FIG. 2, there is shown an embodiment of the stabilization chamber. At its top, the chamber 17 comprises a gas diffuser 21 in the form of a shower head. The substrate carrier 22 is arranged facing the gas diffuser 21 and it receives the substrate 23 for treatment. The substrate carrier 22 may possibly act as a heater.

At the bottom of the chamber 17 there can be seen an adjustable throttle valve 24 (butterfly valve) that connects this chamber to a pump unit 25.

In any event, the substrate remains in a vacuum until its surface has been stabilized, in other words the stabilization step follows immediately after the doping step.

The implementations of the invention described above have been selected because of their concrete natures. Nevertheless, it is not possible to list exhaustively all implementations covered by the invention. In particular, any step or any means described may be replaced by an equivalent step or means without going beyond the ambit of the present invention.

1. A method of treating a substrate (23) comprising a doping step followed immediately by a stabilization step, the method being characterized in that said stabilization step comprises immersing the substrate in a gas forming part of the set consisting of: oxygen; water vapor; wet air; hydrogen peroxide vapor; ozone; and ammonia.

2. A method according to claim 1, characterized in that the stabilization step comprises sweeping the substrate (23) with said gas.

3. A method according to claim 1, characterized in that said stabilization step comprises performing at least one cycle comprising a step of introducing said gas followed by a step of purging by pumping.

4. A method according to claim 1, characterized in that said doping step is performed by ion implantation.

5. A method according to claim 4, characterized in that the ion implantation is performed by plasma immersion (15, 16).

6. A method according to claim 1, characterized in that said stabilization step includes a stage of heating the substrate (23).

7. A method according to claim 1, characterized in that said gas comprises gaseous species coming from a plasma.

8. A method according to claim 1, characterized in that said stabilization step is followed by a step of analyzing a residual atmosphere.

9. A machine for treating a substrate by the method in accordance with claim 1, the machine comprising a doping chamber (15, 16) and an orifice (21) for introducing said gas, the machine being characterized in that it includes a stabilization member (13, 14; 17) outside said doping chamber, said stabilization step being performed in said member.

10. A machine according to claim 9, characterized in that said stabilization member is an evacuated airlock (13, 14).

11. A machine according to claim 9, characterized in that said stabilization member is a stabilization chamber (17).
